(19) United States
(12) Patent Application Publication
(10) Pub. No.: US 2012/0068540 A1
(43) Pub. Date: Mar. 22, 2012

(54) ENERGY STORAGE SYSTEM FOR BALANCING LOAD OF POWER GRID

(76) Inventors: Hongbin Luo, Shenzhen (CN); Yunhao Liao, Shenzhen (CN); Zifeng Zhang, Shenzhen (CN); Yinghui Wang, Shenzhen (CN); Linwang Deng, Shenzhen (CN); Shaowen Yin, Shenzhen (CN); Donghong Chen, Shenzhen (CN); Xiaohua Tang, Shenzhen (CN); Juan Xu, Shenzhen (CN)

(21) Appl. No.: 13/305,125

(22) Filed: Nov. 28, 2011

Related U.S. Application Data
(63) Continuation of application No. PCT/CN2010/071928, filed on Apr. 20, 2010.

(30) Foreign Application Priority Data
May 27, 2009 (CN) 200920132427.1

(51) Int. Cl. H02J 3/32; H02J 3/38

(52) U.S. Cl. 307/48; 307/44

(57) ABSTRACT

An energy storage system for balancing the load of a power grid, said energy storage system comprising: a controller; a plurality of energy storage tanks connected in parallel; and a plurality of controllable switches connected to the plurality of energy storage tanks, wherein the controller is configured to detect a frequency and a phase of the power grid, and to balance the load of the power grid based on the frequency and the phase of the power grid, by controlling the plurality of controllable switches to charge the plurality of energy storage tanks using power from the power grid or to input power from the plurality of energy storage tanks to the power grid.

### CROSS-REFERENCE TO RELATED APPLICATION

This application is a continuation of International Application No. PCT/CN2010/071928, filed on Apr. 20, 2010, which claims the benefit of priority to Chinese Patent Application No. 200920132427.1, filed on May 27, 2009, both of which are incorporated by reference in their entirety.

### TECHNICAL FIELD

The present invention generally relates to an energy storage system in a power grid, in particular, to an energy storage system for balancing the load of the power grid.

### BACKGROUND

Rapid industrial and agricultural developments, together with improved standards of living, have given rise to an increasing demand for power, that is stretching the capacities of existing thermal power and hydropower energy storage/generating stations.

Capacity issues dealing with power consumption may arise due to the variation of the load of the power grid at different times of a day. For example, the peak period for electricity consumption is usually between 6 p.m. to 9 p.m. in any given day. A backup energy storage station may be needed to support the power grid to meet the electric power consumption during the peak period, in case electricity consumption exceeds the capacity/output of the power grid. Presently, power stations provide backup energy storage for the power grid in the form of coal energy, oil energy, hydropower, or water-pumping energy storage stations.

However, the above-mentioned energy storage stations have some disadvantages. For example, power stations for energy storage using coal and oil are expensive, require a long time to start or stop, and often cause serious pollution to the environment. Thus, when factors such as cost, safety, and environmental concerns are taken into account, energy storage stations using coal or oil may not be optimal for adjusting the load of the power grid during peak power consumption periods.

Power stations for energy storage using hydropower have more capabilities for regulating peak power consumption. However, the available hydropower resource is limited. Power stations using hydropower also have additional constraints because they require a lot of space, long construction time, and are restricted by certain geographical conditions. Therefore, new systems of energy storage are needed to meet the rising demand for power, especially during peak periods of power consumption.

### SUMMARY OF THE INVENTION

The present invention is directed to solve at least one of the problems existing in the prior art.

Accordingly, an energy storage system for balancing the load of a power grid is provided, said energy storage system comprising: a controller, a plurality of energy storage tanks connected in parallel, and a plurality of controllable switches connected to the plurality of energy storage tanks, wherein the controller is configured to detect a frequency and a phase of the power grid, and to balance the load of the power grid based on the detected frequency and phase of the power grid, by controlling the plurality of controllable switches to charge the plurality of energy storage tanks using power from the power grid or to input power from the plurality of energy storage tanks to the power grid.

### BRIEF DESCRIPTION OF THE DRAWINGS

These and other aspects and advantages of the invention will become apparent and more readily appreciated from the following descriptions taken in conjunction with the drawings in which:

FIG. 1 shows a structural schematic view of an energy storage system according to an embodiment of the present invention;

FIG. 2 shows a structural schematic view of an energy storage tank in an energy storage system according to an embodiment of the present invention;

FIG. 3 shows a structural schematic view of an energy storage system according to another embodiment of the present invention.

FIG. 4 shows a structural schematic view of an energy storage tank in an energy storage system according to another embodiment of the present invention;

### DETAILED DESCRIPTION OF EMBODIMENTS OF THE INVENTION

The aforementioned features and advantages of the present invention will be clear from the detailed description of the following embodiments and the drawings.

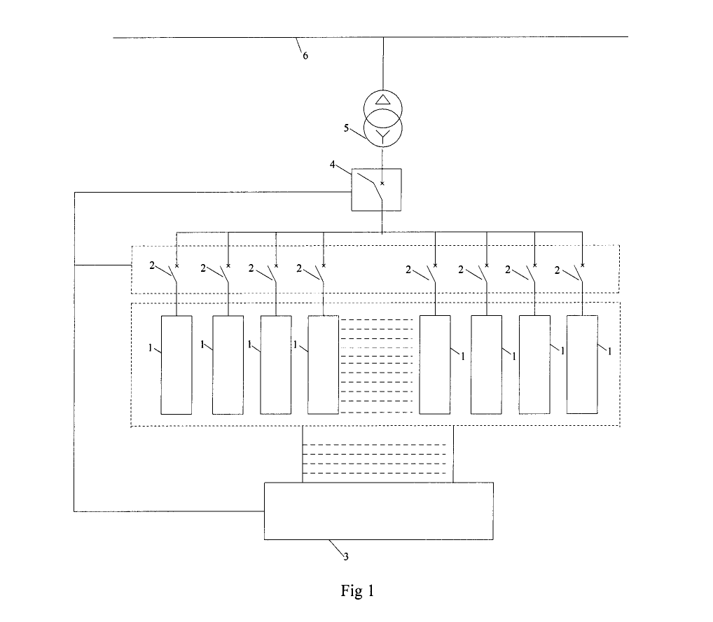

FIGS. 1-4 generally show an energy storage system for balancing the load of a power grid. The energy storage system may comprise: a controller 3, a plurality of energy storage tanks 1 connected in parallel, and a plurality of controllable switches 2 connected to the plurality of energy storage tanks 1. The controller 3 is configured to detect the frequency and phase of the power grid, and to balance the load of the power grid based on the detected frequency and phase of the power grid, by controlling the plurality of controllable switches to charge the plurality of energy storage tanks using power from the power grid or to input power from the plurality of energy storage tanks to the power grid.

In some embodiments, the controller 3 has a plurality of output terminals, and each of the plurality of output terminals is connected to a controlling terminal on each of the plurality of controllable switches 2. The controller 3 controls the plurality of energy storage tanks to charge or discharge power via switching on or off the plurality of controllable switches.

In some embodiments, the controllable switch 2 may be a triode, an FET, or a relay. The controllable switch 2 may be switched on or off according to a control signal from the controller, which subsequently controls the charging and discharging of the energy storage system.

The energy storage tank 1 comprises: a battery array 12; a bi-directional inverter unit 11 configured to charge the battery array using power from the power grid and to input power from the battery array 12 to the power grid; and a monitoring unit 10 configured to receive the control signal of the controller 1, and to control the bi-directional inverter unit 11 to charge the battery array 12 using power from the power grid and to input power from the battery array 12 to the power grid based on the phase and frequency of the power grid, thereby balancing the load of the power grid. The battery pack in the battery array 12 may comprise a plurality of serially connected batteries, for example, Ferrous batteries (that is, lithium iron phosphate batteries which may have a rating voltage of 3.2V), or other types of batteries. The bi-directional inverter unit 11 is configured to convert the AC from the power grid into DC, and to charge the battery array 12 by DC. The bi-directional inverter unit 11 may be any inverter unit having a suitable structure as long as the unit can realize the above functions.

In an embodiment of the present invention, the energy storage tank 1 further comprises a transformer 13, and the transformer 13 is connected to the bi-directional inverter unit 11. The transformer 13 is configured to: convert a high voltage power from the power grid into a low voltage power, supply the low voltage power to the bi-directional inverter unit 11, and facilitate the bi-directional inverter unit 11 to charge the battery array using the low voltage power; and to convert a low voltage power from the bi-directional inverter unit 11 into a high voltage power having a same voltage as the power grid, and to input the high voltage power into the power grid.

In another embodiment of the present invention, the energy storage tank 1 further comprises an electric relay protection unit 14 configured to protect the transformer 13. The electric relay protection unit 14 may comprise a high voltage side incoming line cabinet protection device, a high voltage side outgoing line cabinet protection device, a low voltage side incoming line cabinet protection device, and a low voltage side outgoing line cabinet protection device. The high voltage side incoming line cabinet protection device and the high voltage outgoing line cabinet protection device may be disposed inside the high voltage side incoming line cabinet and the high voltage side outgoing line cabinet of the transformer respectively. Likewise, the low voltage side incoming line cabinet protection device and the low voltage side outgoing line cabinet protection device may be disposed inside the low voltage side incoming line cabinet and the low voltage side outgoing line cabinet of the transformer respectively. The high voltage side incoming line cabinet protection device may include switch components, a lightning arrester, and other electric display devices which isolate the high voltage power supply to ensure safety during maintenance and repair. In an embodiment of the present invention, the high voltage side outgoing line cabinet protection device may further include a CSP-2000 microcomputer system for realizing over-current protection, instantaneous trip current protection, high temperature alarm, over-temperature tripping, and zero sequence current protection. The low voltage side incoming line cabinet protection device and the low voltage side outgoing line cabinet protection device may be configured to perform delay in case of overloading or instantaneous protection when a short circuit occurs. In some embodiments, the low voltage side incoming line cabinet protection device and the low voltage side outgoing line cabinet protection device may employ a controllable delay switch, such as, a time delay relay and RC delay circuit and so forth.

In another embodiment of the present invention, the energy storage tank 1 further comprises a heating unit 15 configured to increase the temperature of the energy storage tank. The heating unit 15 is connected to the monitoring unit 10 and the battery array 12. The battery array 12 in the energy storage tank 1 may have a low work efficiency in a low temperature environment, for example, in the winter. The battery array 12 may have an optimal work efficiency at certain temperatures. The heating unit 15 may be used for preheating. When the monitoring unit 10 detects that temperature in the energy storage tank is below the temperature for the battery's optimal working efficiency, the heating unit 15 preheats the environment in the energy storage tank to a predetermined temperature, normally about 25° C., before the control unit starts the charging or the discharging process. In an embodiment, the heating unit will stop heating once the battery unit starts working. The heating unit 15 may comprise a temperature controller and a heater. The temperature controller detects the temperature inside the energy storage tank, and when the temperature is below a certain predetermined value, the heater will turn on, which increases the temperature in the energy storage tank.

In another embodiment of the present invention, the energy storage tank 1 further comprises an exhausting unit 16 configured to lower the temperature of the energy storage tank 1. The exhausting unit 16 is connected to the monitoring unit 10 and the battery array 12. When the energy storage tank 1 is working in a high temperature environment, for example in the summer, the energy storage system may produce excess heat. If the excess heat is not effectively dissipated from the energy storage tank, the usage life and performance of the energy storage tank may be affected. By monitoring the temperature of the energy storage tank, the monitoring system 10 may control the exhausting system to maintain the energy storage tank at an optimal environment so that the energy storage system may function properly. In an embodiment, the exhausting unit 16 comprises a fan and a breaker. The fan is connected to the battery array via the breaker. If the temperature detected by the monitoring unit exceeds a certain level, the fan turns on to lower the temperature of the energy storage tank.

In another embodiment of the present invention, the energy storage tank 1 further comprises an illuminating unit 18. When the battery is working, personnel entry into the energy storage tank is not permitted. But when the energy storage system fails, a worker may enter the energy storage tank. In an embodiment, when the energy storage tank is under maintenance, the outer power supply may be disconnected, and the illuminating unit 18 in the energy storage tank may use its own backup power supply. During normal operation of the energy storage station, the backup power supply is in a floating charging status. When the energy storage system fails, the worker may disconnect the outer power before entering the energy storage tank, and turn on the backup power supply to power the illuminating unit to aid the system maintenance work.

In another embodiment of the present invention, the energy storage tank 1 further comprises a waterproof unit 17. The waterproof unit 17 is connected to the monitoring unit 10. In an embodiment, the protection degree of the energy storage tank may be about IP55. The waterproof unit 17 may comprise a water immersion alarm device. If water is detected by the water immersion alarm device, a signal is sent to the monitoring unit 10, and the monitoring unit 10 controls the bi-directional inverter unit 11 to stop the conversion between AC and DC, which stops the energy storage tank from operating. A signal is then sent to the controller 3 by the monitoring unit 10, and the controller 3 switches off the corresponding controllable switch of the energy storage tank.

In another embodiment of the present invention, the energy storage tank may be container-shaped, and a plurality of container-shaped energy storage tanks may form an energy storage system. The energy storage system formed by the plurality of container-shaped energy storage tanks may have many advantages over a single energy storage station. For example, the container-shaped energy storage tanks may be easier to transport, require less space, and are safer to operate. An energy storage system having the same power as a single energy storage station may be formed conveniently from the plurality of container-shaped energy storage tanks.

In another embodiment of the present invention, at least one grounding energy storage tank is provided in the energy storage system. The neutral point of the transformer in the grounding energy storage tank is not grounded. The internal equipment may be connected to the energy storage tanks via grounding copper bars. The grounding resistance between the energy storage tanks may be below 4 Ω. In another embodiment of the present invention, the energy storage tank may further comprise a battery support for fixing the battery array, so that the fixed battery array is protected from vibration during transportation which could affect the battery performance.

### Embodiment 1

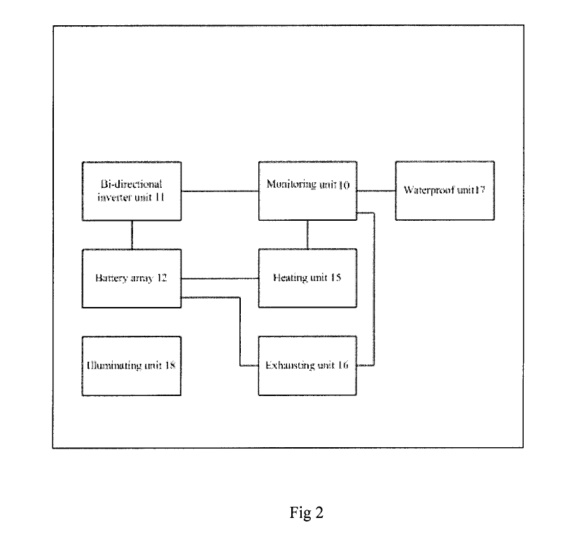

As shown in FIGS. 1 and 2, an energy storage system for balancing the load of the power grid is shown, the system comprising: a controller 3, a plurality of energy storage tanks 1 connected in parallel, and a plurality of controllable switches 2 connected to the plurality of energy storage tanks 1. The controller 3 is configured to detect the frequency and phase of the power grid 6, and to balance the load of the power grid 6 based on the frequency and phase of the power grid, by controlling the controllable switch 2 to charge the plurality of energy storage tanks using power from the power grid 6 or to input power from the plurality of energy storage tanks to the power grid. The energy storage system further comprises a transformer 5. The transformer 5 is connected between the power grid and the controllable switch. The transformer 5 is configured to convert high voltage power from the power grid into low voltage power, and to supply the low voltage power to charge the battery array via the controllable switch; and to convert the low voltage power into high voltage power having the same voltage as the power grid, and to input the high voltage power into the power grid. The energy storage system further comprises a main switch 4, and the main switch 4 is connected to the controller 3. The energy storage tank comprises a battery array, a bi-directional inverter unit 11 configured to charge the battery array using power from the power grid and to input power from the battery array 12 to the power grid, and a monitoring unit 10. The plurality of monitoring units in the plurality of energy storage tanks are connected to a plurality of output terminals in the controller. The plurality of monitoring units are configured to receive the control signal of the controller, control the bi-directional inverter unit to charge the battery array using power from the power grid, and to input power from the battery array to the power grid based on the phase and frequency of the power grid, thereby balancing the load of the power grid.

If the controller detects that power from the power grid does not meet the consumers' demands, that is, the system is in a discharging state, the following actions may be performed: The controller switches on the main switch 4, and determines whether the capacity of the energy storage tank detected by the monitoring unit in the energy storage tank is in an allowable discharge range. If the capacity of the energy storage tank is in the allowable discharge range, the controller switches on the corresponding controllable switch of the energy storage tank. Meanwhile, the controller sends a signal to the monitoring unit 10 of the energy storage tank 1, and the monitoring unit 10 controls the bi-directional inverter unit 11 to discharge the battery array 12. The controller controls at least one energy storage tank to discharge, and the discharged power is converted by the transformer 5, based on the frequency and phase of the power grid, and input into the power grid, thereby balancing the load of the power grid.

When the controller detects extra power from the power grid, the status of the system goes into a charging time period, and the following operations may be performed: The controller switches on the main switch 4, and determines whether the energy storage tank needs to be charged via the monitoring unit. If the energy storage tank needs to be charged, the controller switches on the corresponding controllable switch of the energy storage tank. Meanwhile, the controller controls the monitoring unit to charge the battery array via the bi-directional inverter unit using power from the power grid. When the controller detects any abnormal situations via the monitoring unit in the energy storage tank, for example, excessively high voltage/current or water entering the energy storage tank and so forth, the controller switches off the controllable switch, thus stopping the operation of the energy storage tank.

### Embodiment 2

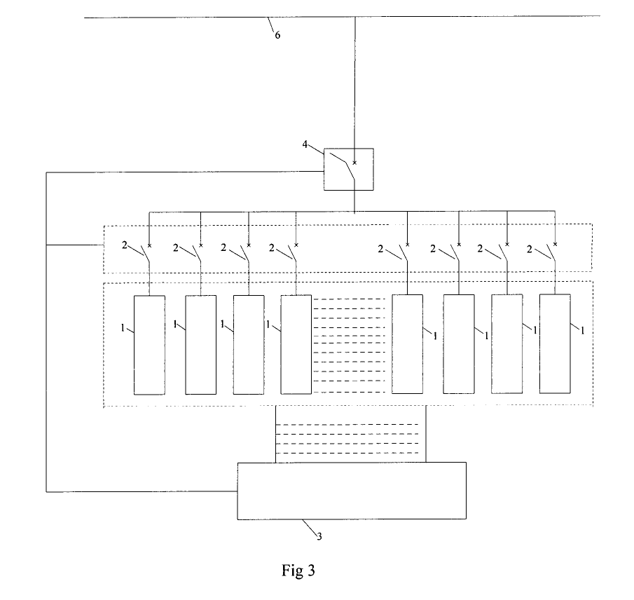

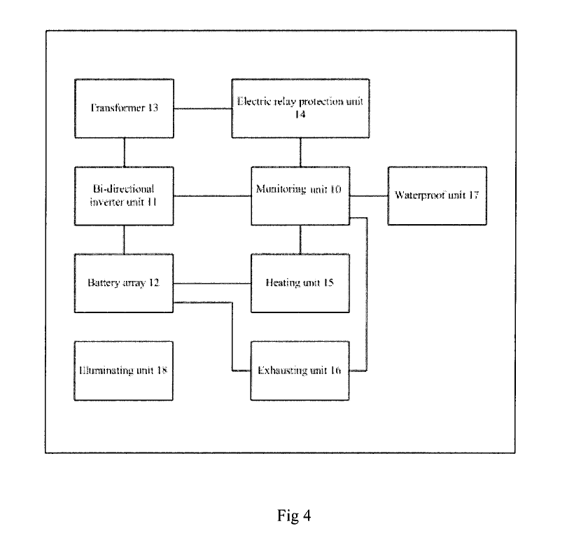

As shown in FIGS. 3 and 4, an energy storage system for balancing the load of the power grid is shown, the system comprising: a controller 3, a plurality of energy storage tanks 1 connected in parallel, and a plurality of controllable switches 2 connected to the plurality of energy storage tanks. The controller 3 is configured to detect the frequency and phase of the power grid 6, and to balance the load of the power grid 6 based on the frequency and phase of the power grid, by controlling the controllable switch to charge the plurality of energy storage tanks using power from the power grid 6 or to input power from the plurality of energy storage tanks to the power grid.

The energy storage system further comprises a main switch 4 which is connected to the controller 3. The energy storage tank comprises: a battery array; a bi-directional inverter unit 11 configured to charge the battery array using power from the power grid and to input power from the battery array 12 to the power grid; and a monitoring unit 10 configured to receive the control signal of the controller 1 and control the bi-directional inverter unit 11 to charge the battery array 12 using power from the power grid, and to input power from the battery array 12 to the power grid based on the phase and frequency of the power grid, thereby balancing the load of the power grid.

The energy storage system further comprises a transformer 13. The transformer 13 is connected between the power grid and the controllable switch. The transformer 13 is configured to convert high voltage power from the power grid into low voltage power and to supply the low voltage power to charge the battery array via the controllable switch; and to convert low voltage power into high voltage power having the same voltage as the power grid, and to input the high voltage power into the power grid.

When the controller detects a power deficiency from the power grid that may not meet the consumers' needs, the status of the system goes into a discharging time period, and the followings operations may be performed: The controller switches on the main switch 4, and determines whether the capacity of the energy storage tank detected by the monitoring unit in the energy storage is in an allowable discharge range. If the capacity is in the allowable discharge range, the controller switches on the corresponding controllable switch of the energy storage tank. Meanwhile, the controller sends a signal to the monitoring unit 10 of the energy storage tank 1, and the monitoring unit 10 controls the bi-directional inverter unit 11 to discharge the battery array 12. The controller controls at least one energy storage tank to discharge, and the discharged power is converted by the transformer 5 based on the frequency and phase of the power grid, and input into the power grid, thereby balancing the load of the power grid.

When the controller detects excess power from the power grid, the status of the system goes into a charging time period, and the following operations may be performed: The controller switches on the main switch 4, and the controller determines whether the energy storage tank needs to be charged via the monitoring unit. If the energy storage tank needs to be charged, the controller switches on the corresponding controllable switch of the energy storage tank. Meanwhile, the controller controls the monitoring unit to charge the battery array via the bi-directional inverter unit using power from the power grid. When the controller detects any abnormal situations via the monitoring unit in the energy storage tank, for example, excessively high voltage/current or water entering the energy storage tank and so forth, the controller switches off the controllable switch, thus stopping the operation of the energy storage tank.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

What is claimed is:

1. An energy storage system for balancing the load of a power grid, said energy storage system comprising:
a controller;
a plurality of energy storage tanks connected in parallel; and
a plurality of controllable switches connected to the plurality of energy storage tanks,
wherein the controller is configured to detect a frequency and a phase of the power grid, and to balance the load of the power grid based on the detected frequency and phase of the power grid, by controlling the plurality of controllable switches to charge the plurality of energy storage tanks using power from the power grid or to input power from the plurality of energy storage tanks to the power grid.

2. The energy storage system according to claim 1, wherein the controller has a plurality of output terminals, and each of the plurality of output terminals is connected to a controlling terminal on each of the plurality of controllable switches, and said controller controls the plurality of energy storage tanks to charge or discharge via switching on or off the plurality of controllable switches.

3. The energy storage system according to claim 1, wherein each of the plurality of energy storage tanks comprises:
a battery array;
a bi-directional inverter unit configured to charge the battery array using power from the power grid or to input power from the battery array to the power grid; and
a monitoring unit configured to receive a control signal from the controller, and to control the bi-directional inverter unit to charge the battery array using power from the power grid or to input power from the battery array to the power grid, based on the phase and frequency of the power grid, thereby balancing the load of the power grid.

4. The energy storage system according to claim 3, wherein each of the plurality of energy storage tanks further comprises a transformer connected to the bi-directional inverter unit, wherein the transformer is configured to:
convert high voltage power from the power grid into low voltage power, supply the low voltage power to the bi-directional inverter unit, and facilitate the bi-directional inverter unit to charge the battery array using the low voltage power; and to
convert low voltage power from the bi-directional inverter unit into high voltage power having a same voltage as the power grid, and to input the high voltage power to the power grid.

5. The energy storage system according to claim 4, wherein each of the plurality of energy storage tanks further comprises an electric relay protection unit configured to protect the transformer.

6. The energy storage system according to claim 3, wherein each of the plurality of energy storage tanks further comprises a heating unit connected to the monitoring unit and the battery array, and configured to increase a temperature of each of the plurality of energy storage tanks.

7. The energy storage system according to claim 3, wherein each of the plurality of energy storage tanks further comprises an exhausting unit connected to the monitoring unit and the battery array, and configured to lower a temperature of each of the plurality of energy storage tanks.

8. The energy storage system according to claim 3, wherein each of the plurality of energy storage tanks further comprises a water immersion alarm device connected to the monitoring unit, and configured to provide an alert when water enters into each of the plurality of energy storage tanks.

9. The energy storage system according to 3, wherein each of the plurality of energy storage tanks further comprises a transformer connected between the power grid and the controllable switch, and configured to:
convert high voltage power from the power grid into low voltage power, and to charge each of the plurality of energy storage tanks via the controllable switch using the low voltage power; and to
convert low voltage power from the energy storage tank into high voltage power having a same voltage as the power grid, and to input the high voltage power into the power grid.

10. The energy storage system according to claim 1, wherein each of the plurality of energy storage tanks is container-shaped.
